(19) United States
(12) Patent Application Publication
(10) Pub. No.: US 2026/0181251 A1
(43) Pub. Date: Jun. 25, 2026

(54) CONTROL APPARATUS, IMAGE PICKUP APPARATUS, CONTROL METHOD, AND STORAGE MEDIUM

(71) Applicant: CANON KABUSHIKI KAISHA, Tokyo (JP)

(72) Inventor: SHUN NISHIKAWA, Kanagawa (JP)

(21) Appl. No.: 19/408,742

(22) Filed: Dec. 4, 2025

(30) Foreign Application Priority Data
Dec. 25, 2024 (JP) 2024-229419

(51) Int. Cl. H04N 23/67; H04N 23/667

(52) U.S. Cl. CPC H04N 23/67; H04N 23/667

(57) ABSTRACT

Control apparatuses, image pickup apparatuses, control methods, and storage media are provided herein. One or more control apparatuses may include one or more memories storing instructions, and one or more processors that, upon execution of the instructions, operate to acquire first information on a first image-plane position of an object using time-series focus detection results based on image signals obtained from an image sensor, acquire second information on a future second image-plane position of the object using the first information, control a focus lens using the first information in a case where a motion of the object is in a first state, and control the focus lens using the second information in a case where the motion of the object is in a second state greater than the first state.

### BACKGROUND

### Field of the Technology

The disclosure relates to one or more embodiments of a control apparatus, an image pickup apparatus, a control method, and a storage medium.

### Description of the Related Art

Conventional image pickup apparatuses have an autofocus (AF) function that automatically performs focusing based on a defocus amount, which is a focus detection result obtained using a signal from an image sensor. Japanese Patent Application Laid-Open No. 2019-91031 discloses a method for suppressing variation using a defocus amount obtained by averaging chronologically detected defocus amounts, or a defocus amount detected by averaging chronologically captured focus detecting signals. Japanese Patent Application Laid-Open No. 2021-9197 discloses a method for predicting a future focus position of an object from time-series defocus amounts in a case where the object is moving, and predicting the future focus position of the object from a smaller number of time-series defocus amounts in a case where the object is not moving.

The method disclosed in Japanese Patent Application Laid-Open No. 2019-91031 assumes a stationary object and may not be able to accurately detect a defocus amount for a moving object. In the method disclosed in Japanese Patent Application Laid-Open No. 2021-9197, even if a smaller number of time-series defocus amounts are used, if the defocus amounts vary, errors will occur in predicting the future focus position of the object, and the control of the focus lens becomes unstable.

### SUMMARY

One or more control apparatuses according to one or more aspects of the disclosure may include one or more memories storing instructions, and one or more processors that, upon execution of the instructions, operate to acquire first information on a first image-plane position of an object using time-series focus detection results based on image signals obtained from an image sensor, acquire second information on a future second image-plane position of the object using the first information, control a focus lens using the first information in a case where a motion of the object is in a first state, and control the focus lens using the second information in a case where the motion of the object is in a second state greater than the first state. One or more image pickup apparatuses may include one or more control apparatuses in accordance with one or more other aspects of the disclosure. One or more control methods corresponding to the above one or more control apparatuses also constitutes another aspect of the disclosure. A storage medium storing a program that causes a computer to execute the above one or more control methods also constitutes another aspect of the disclosure.

Features of the present disclosure will become apparent from the following description of embodiments with reference to the attached drawings. The following description of embodiments will be described by way of example.

### BRIEF DESCRIPTION OF THE DRAWINGS

FIG. 1 is a block diagram of an image pickup apparatus according to this embodiment.

FIG. 2 is a schematic diagram of a pixel array in this embodiment.

FIGS. 3A and 3B are a schematic plan view and a schematic sectional view of pixels in this embodiment.

FIG. 4 is a schematic diagram of pixels and pupil division in this embodiment.

FIG. 5 is a schematic diagram of an image sensor and pupil division in this embodiment.

FIG. 6 is a schematic diagram of a relationship between a defocus amount and an image shift amount in this embodiment.

FIG. 7 explains Kalman filter calculation according to this embodiment.

FIG. 8 is a flowchart illustrating motion (or movement) determination processing according to this embodiment.

FIG. 9 illustrates an example of an image-plane position of an object that is used in motion determination in this embodiment.

FIG. 10 illustrates an example of an image-plane position of an object that is used to calculate a predicted image plane information in this embodiment.

FIG. 11 is a flowchart illustrating focusing processing in this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### Configuration of Image Pickup Apparatus

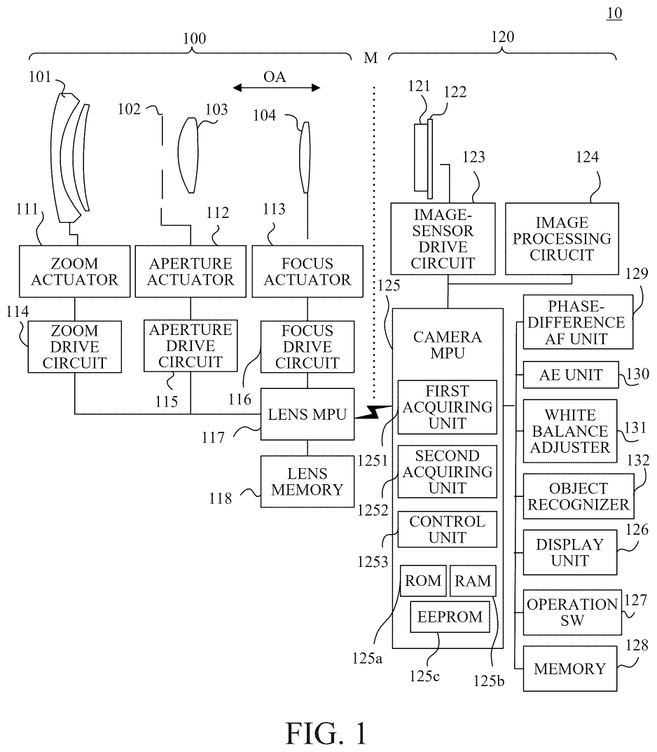

Referring now to FIG. 1, the configuration of an image pickup apparatus according to this embodiment will be described. FIG. 1 is a block diagram of an imaging (or image capturing) system 10 (a single-lens reflex digital camera system having an interchangeable lens) according to this embodiment. The imaging system 10 includes a lens unit (interchangeable lens, lens apparatus) 100 and a camera body (image pickup apparatus) 120. The lens unit 100 is attachable to and detachable from the camera body 120 via a mount M, indicated by a dotted line in FIG. 1. However, this embodiment is not limited to this example and can also be applied to an image pickup apparatus (digital camera) in which the lens unit (imaging optical system) and camera body are integrated. This embodiment is also not limited to digital cameras and can be applied to other image pickup apparatuses such as video cameras.

The lens unit 100 includes an optical system consisting of a first lens unit 101, an aperture stop (diaphragm) 102, a second lens unit 103, a focus lens (focus lens unit) 104, and a drive/control system. As such, the lens unit 100 includes an imaging optical system that includes the focus lens 104 and forms an object image.

The first lens unit 101 is located at the tip of the lens unit 100 and is held so that it can move back and forth in the optical axis direction OA. The aperture stop 102 adjusts a light amount during imaging by adjusting its aperture diameter, and also functions as a shutter for exposure time adjustment in capturing still images. The aperture stop 102 and the second lens unit 103 can move together in the optical axis direction OA, and achieve a zoom function in conjunction with the forward and backward movement of the first lens unit 101. The focus lens 104 can move in the optical axis direction OA, and an object distance (focal length) at which the lens unit 100 focuses changes according to its position. Controlling the position of the focus lens 104 in the optical axis direction OA enables focusing (focus control) to adjust the focal length of the lens unit 100.

The drive/control system includes a zoom actuator 111, an aperture actuator 112, a focus actuator 113, a zoom drive circuit 114, an aperture drive circuit 115, a focus drive circuit 116, a lens MPU 117, and a lens memory 118. The zoom drive circuit 114 uses the zoom actuator 111 to drive the first lens unit 101 and the second lens unit 103 in the optical axis direction OA, thereby controlling the angle of view of the optical system in the lens unit 100 (performing a zoom operation). The aperture drive circuit 115 uses the aperture actuator 112 to drive the aperture stop 102, controlling the aperture diameter and opening/closing operation of the aperture stop 102. The focus drive circuit 116 uses the focus actuator 113 to drive the focus lens 104 in the optical axis direction OA, thereby controlling the focal length of the optical system in the lens unit 100 (performing a focus control). The focus drive circuit 116 also functions as a position detector that uses the focus actuator 113 to detect the current position (lens position) of the focus lens 104.

The lens MPU (processor) 117 performs all calculations and controls related to the lens unit 100, and controls the zoom drive circuit 114, aperture drive circuit 115, and focus drive circuit 116. The lens MPU 117 is also connected to the camera MPU 125 via the mount M to communicate commands and data. For example, the lens MPU 117 detects the position of the focus lens 104 and notifies the camera MPU 125 of lens position information in response to a request. This lens position information includes information such as the position of the focus lens 104 in the optical axis direction OA, the position and diameter of the exit pupil in the optical axis direction OA when the optical system is not moving, and the position and diameter of a lens frame that limits a light beam from the exit pupil in the optical axis direction OA. The lens MPU 117 also controls the zoom drive circuit 114, aperture drive circuit 115, and focus drive circuit 116 according to a request from the camera MPU 125. The lens memory 118 stores optical information necessary for AF (AF control). The camera MPU 125 controls the operation of the lens unit 100 by executing programs stored, for example, in an internal nonvolatile memory or the lens memory 118.

The camera body 120 includes an optical low-pass filter 121, an image sensor 122, and a drive/control system. The optical low-pass filter 121 and image sensor 122 function as an imaging unit configured to photoelectrically convert an object image (optical image) formed via the lens unit 100 and output image data. In this embodiment, the image sensor 122 photoelectrically converts the object image formed via the imaging optical system and outputs an imaging signal and a focus detecting signal as image data. In this embodiment, the first lens unit 101, the aperture stop 102, the second lens unit 103, the focus lens 104, and the optical low-pass filter 121 constitute the imaging optical system.

The optical low-pass filter 121 reduces false colors and moiré in captured images. The image sensor 122 includes a CMOS image sensor and its peripheral circuits, and has m pixels horizontally and n pixels vertically (where m and n are integers greater than or equal to 2). In this embodiment, the image sensor 122 also functions as a focus detecting element and a pupil division, and has pupil dividing pixels that enable phase-difference detection focus detection (phase-difference AF) using image data (image signals). Based on the image data output from the image sensor 122, the image processing circuit 124 generates data for phase-difference AF and image data for display, recording, and object recognition.

The drive/control system includes an image sensor drive circuit 123, an image processing circuit 124, a camera MPU 125, a display unit 126, a group of operation switches (operation SW) 127, and a memory 128. The drive/control system also includes a phase-difference AF unit (focus detector) 129, an (auto-exposure) AE unit 130, a white balance adjuster 131, and an object recognizer 132.

The image sensor drive circuit 123 controls the operation of the image sensor 122, and A/D-converts the image signal (image data) output from the image sensor 122 and sends it to the camera MPU 125. The image processing circuit 124 performs general image processing performed in digital cameras, such as gamma conversion, color interpolation, and compression encoding, for the image signal output from the image sensor 122. The image processing circuit 124 also generates a signal for phase-difference AF (or a phase-difference AF signal), a signal for AE (or an AE signal), a signal for white balance adjustment (or a white balance adjustment signal), and a signal for object recognition (or an object recognition signal). In this embodiment, the signal for phase-difference AF, the signal for AE, the signal for white balance adjustment, and the signal for object recognition are generated separately, but for example, the signal for AE, the signal for white balance adjustment, and the signal for object recognition may also be generated as a common signal. The combination of common signals is not limited to this example.

The camera MPU (one or more processors, control apparatus) 125 performs all calculations and control related to the camera body 120. That is, the camera MPU 125 controls the image sensor drive circuit 123, image processing circuit 124, display unit 126, operation switch group 127, memory 128, phase-difference AF unit 129, AE unit 130, white balance adjuster 131, and object recognizer 132. The camera MPU 125 is connected to the lens MPU 117 via the signal line of the mount M, and communicates commands and data with the lens MPU 117. The camera MPU 125 issues requests to the lens MPU 117 to acquire the lens position and to drive the lens by a specified drive amount, and also issues requests from the lens MPU 117 to acquire optical information specific to the lens unit 100.

The camera MPU 125 incorporates a ROM 125a that stores programs (including instructions) that control the operation of the camera body 120, a RAM (camera memory) 125b that stores variables, and an EEPROM 125c that stores various parameters. The camera MPU 125 executes focus detection processing based on the program stored in ROM 125a. In focus detection processing, known correlation calculation processing is performed using a pair of image signals obtained by photoelectrically converting optical images formed by light beams passing through different pupil regions (pupil subregions) in the imaging optical system.

The camera MPU 125 has a first acquiring unit 1251, a second acquiring unit 1252, and a control unit 1253. The camera MPU 125, upon execution of the instructions stored in the ROM 125a, operate to serve as the first acquiring unit 1251, the second acquiring unit 1252, and the control unit 1253. The first acquiring unit 1251 acquires first information (estimated image-plane information) on the first image-plane position of the object using time-series focus detection results (defocus amount) based on the image signal obtained from the image sensor 122. The second acquiring unit 1252 uses the first information to acquire second information (image shift amount) on the future second image-plane position of the object. The control unit 1253 controls the focus lens 104 using the first information or the second information according to the motion of the object. The phase-difference AF unit 129 may have at least part of the functions (part of the functions as the control apparatus) of the first acquiring unit 1251, the second acquiring unit 1252, and the control unit 1253.

The display unit 126 includes an LCD or the like, and displays information about the imaging mode of the imaging system 10, a preview image before imaging and an image for confirmation (or a confirmation image) after imaging, and an image illustrating a focus state during focus detection. The operation switch group 127 includes a power switch, shutter button (imaging trigger), zoom operation switch, imaging mode selecting switch, etc. The memory (recorder) 128 is a removable flash memory and records captured images.

The phase-difference AF unit 129 performs focus detection processing using a phase-difference detecting method based on the image signal of image data for focus detection (signal for phase-difference AF) obtained from the image sensor 122 and image processing circuit 124. More specifically, the image processing circuit 124 generates a pair of image data formed by light beams passing through a pair of pupil regions in the imaging optical system as data for focus detection (or focus detection data), and the phase-difference AF unit 129 detects a defocus amount based on a shift amount between the pair of image data. Thus, the phase-difference AF unit 129 in this embodiment performs phase-difference AF (imaging-surface phase-difference AF) based on the output of the image sensor 122 without using a dedicated AF sensor.

The AE unit 130 performs exposure adjustment processing to make proper an imaging condition by measuring light metering (photometry) based on an AE signal obtained from the image sensor 122 and image processing circuit 124. More specifically, it performs light metering based on the AE signal and calculates the exposure amount based on the currently set aperture value (F-number), shutter speed, and ISO speed (sensitivity). It performs exposure adjustment processing by calculating a proper aperture value, shutter speed, and ISO speed to be set during imaging from a difference between the calculated exposure amount and a predetermined proper exposure amount, and setting them as an imaging condition. The AE unit 130 calculates the exposure condition during imaging using the light metering result, and functions as an exposure adjuster that controls the aperture value, shutter speed, and ISO speed of the aperture stop 102.

The white balance adjuster 131 performs white balance adjustment processing based on the signal for white balance adjustment obtained from the image sensor 122 and image processing circuit 124. More specifically, it calculates white balance of the signal for white balance adjustment and adjusts a color weight based on a difference between the calculated value and the predetermined proper white balance, thereby performing white balance adjustment processing.

The object recognizer 132 performs object recognition processing based on the signal for object recognition generated by the image processing circuit 124. The object recognition processing detects the type and state (detection type) of the object, as well as its position and size (detection area). Details of the operation of the object recognizer 132 will be described later.

As described above, the imaging system 10 according to this embodiment can execute a combination of phase-difference AF, photometry (exposure adjustment), white balance adjustment, and object recognition. The imaging system 10 can select the position (image height range) for phase-difference AF, photometry, and white balance adjustment based on the object recognition result.

### Image Sensor

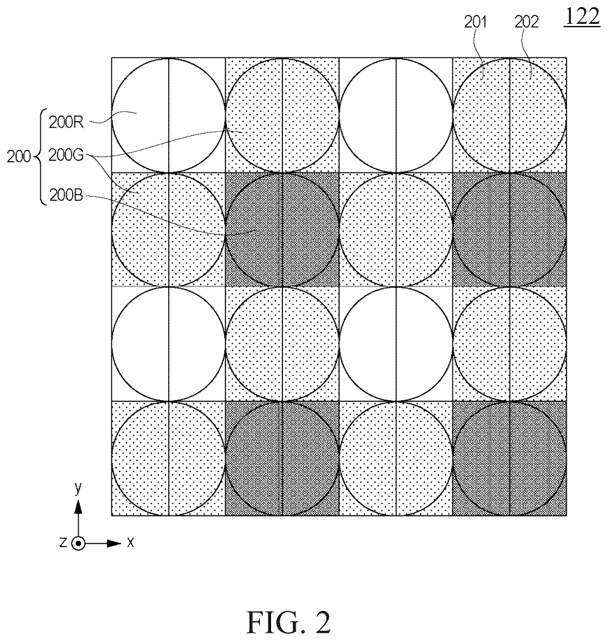

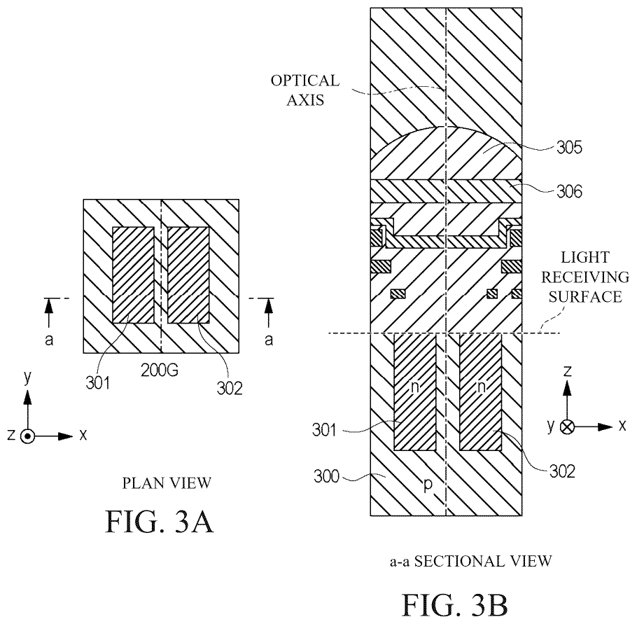

Next, the imaging pixel (and focus detecting pixel) array of the image sensor 122 in this embodiment will be described with reference to FIGS. 2, 3A, and 3B. FIG. 2 is a schematic diagram of the pixel array of the image sensor 122, illustrating the pixel (imaging pixel) array of the two-dimensional CMOS sensor (image sensor) in this embodiment as a 4-column×4-row area and the focus detecting pixel array as an 8-column×4-row area. In this embodiment, the 2-column×2-row pixel group 200 illustrated in FIG. 2 has a pixel 200R with R (red) spectral sensitivity disposed at the upper left, a pixel 200G with G (green) spectral sensitivity disposed at the upper right and lower left, and a pixel 200B with B (blue) spectral sensitivity disposed at the lower right. Each pixel includes a first focus detecting pixel 201 and a second focus detecting pixel 202 arranged in a 2-column×1-row configuration.

A large number of 4-column×4-row pixels (8 columns×4 rows of focus detecting pixels) illustrated in FIG. 2 are arranged on a surface, and thereby a captured image (focus detecting signal) can be acquired. In this embodiment, the image sensor will be described as having a pixel period P of 4 μm, a pixel count N of 5,575 columns horizontally×3,725 rows vertically=approximately 20.75 million pixels, a column-direction period PAF of the focus detecting pixels of 2 μm, and a number of focus detecting pixels NAF of 11,150 columns horizontally×3,725 rows vertically=approximately 41.5 million pixels.

FIG. 3A is a plan view of one pixel 200G in the image sensor 122 illustrated in FIG. 2, viewed from the light receiving surface side (+z side) of the image sensor. FIG. 3B is a sectional view of an a-a cross section in FIG. 3A, viewed from the −y side. In FIGS. 3A and 3B, in the pixel 200G in this embodiment, a microlens 305 is formed on the light receiving side of each pixel to condense incident light, and photoelectric converters 301 and 302 are formed that are NH-divided (divided into two) in the x direction and NV-divided (divided into one) in the y direction. Photoelectric converters 301 and 302 correspond to the first focus detecting pixel 201 and the second focus detecting pixel 202, respectively.

The photoelectric converters 301 and 302 may be pin-structure photodiodes with an intrinsic layer sandwiched between p-type and n-type layers, or, if necessary, the intrinsic layer may be omitted and a pn-junction photodiode may be used. In each pixel, a color filter 306 is formed between the microlens 305 and the photoelectric converters 301 and 302. If necessary, the spectral transmittance of the color filters may be different for each subpixel, or the color filters may be omitted.

Light incident on the pixel 200G illustrated in FIGS. 3A and 3B is condensed by the microlens 305, spectralized by the color filter 306, and then received by the photoelectric converters 301 and 302. In the photoelectric converters 301 and 302, electron-hole pairs are generated according to the amount of received light. After separation by the depletion layer, the negatively charged electrons are accumulated in the n-type layer (not illustrated), while the holes are discharged to the outside of the image sensor through the p-type layer connected to a constant voltage source (not illustrated). Electrons accumulated in the n-type layers (not illustrated) of the photoelectric converters 301 and 302 are transferred to the capacitance section (FD) via a transfer gate and converted into a voltage signal.

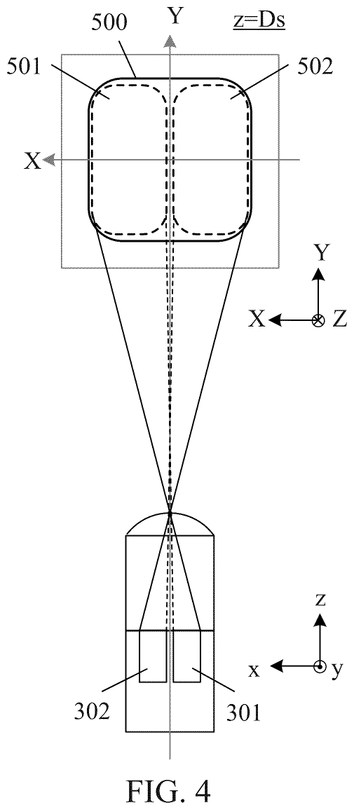

FIG. 4 is a schematic diagram illustrating the correspondence between the pixel structure of this embodiment illustrated in FIGS. 3A and 3B and pupil division. FIG. 4 illustrates a sectional view of the a-a cross section of the pixel structure of this embodiment illustrated in FIG. 3A, viewed from the +y side, and the pupil plane (pupil distance DS) of the image sensor. In FIG. 4, the x-axis and y-axis of the sectional view are inverted relative to those in FIGS. 3A and 3B to correspond to the coordinate axes of the pupil plane of the image sensor 122.

In FIG. 4, the first pupil subregion (or first pupil partial region) 501 of the first focus detecting pixel 201 is in a substantially conjugate relationship with the light receiving surface of the photoelectric converter 301, whose center of gravity is decentered in the −x direction, via the microlens 305. The first pupil subregion 501 is a pupil region that can receive light at the first focus detecting pixel 201. The center of gravity of the first pupil subregion 501 of the first focus detecting pixel 201 is decentered on the +X side on the pupil plane. In FIG. 4, the second pupil subregion (or second pupil partial region) 502 of the second focus detecting pixel 202 is approximately conjugate with the light receiving surface of the photoelectric converter 302, whose center of gravity is decentered in the +x direction, via the microlens. The second pupil subregion 502 is a pupil region that can receive light at the second focus detecting pixel 202. The center of gravity of the second pupil subregion 502 of the second focus detecting pixel 202 is decentered on the −X side on the pupil plane. Also in FIG. 4, a pupil region 500 is the pupil region that can receive light by the entire pixel 200G when the photoelectric converter 301 and photoelectric converter 302 (first focus detecting pixel 201 and second focus detecting pixel 202) are all combined.

In imaging-surface phase-difference AF, the microlens in the image sensor 122 is used for pupil division, which is affected by diffraction. In FIG. 4, a pupil distance to the pupil plane of the image sensor is several tens of millimeters, while the diameter of the microlenses is several micrometers. Therefore, the aperture value of the microlens becomes tens of thousands, and diffraction blur on the order of several tens of millimeters occurs. Hence, the image on the light receiving surface of the photoelectric converter does not have a clear pupil region or pupil subregion, but rather a light-receiving sensitivity characteristic (incident angle distribution of light-receiving rate).

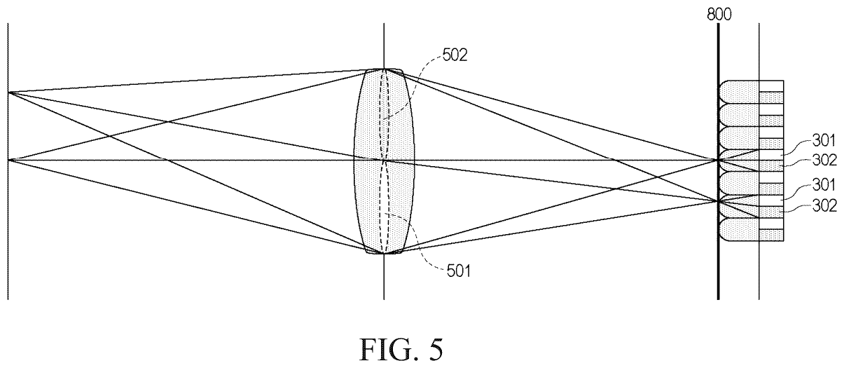

FIG. 5 is a schematic diagram illustrating the correspondence between the image sensor 122 and pupil division in this embodiment. Light beams that pass through different pupil subregions, the first pupil subregion 501 and the second pupil subregion 502, are incident on each pixel of the image sensor 122 at different angles and are received by the first focus detecting pixel 201 and the second focus detecting pixel 202, which are a 2×1 division pair. This embodiment is an example in which the pupil region is divided into two in the horizontal direction. If necessary, the pupil can also be divided vertically.

The image sensor 122 in this embodiment has an array of multiple imaging pixels, each including the first focus detecting pixel 201 and the second focus detecting pixel 202. The first focus detecting pixel 201 receives a light beam that passes through the first pupil subregion 501 of the imaging optical system. The second focus detecting pixel 202 receives a light beam that passes through a second pupil subregion 502 of the imaging optical system that is different from the first pupil subregion 501. The imaging pixel receives a light beam that passes through a pupil region that is a combination of the first and second pupil subregions of the imaging optical system.

In the image sensor 122 of this embodiment, each imaging pixel includes the first focus detecting pixel 201 and the second focus detecting pixel 202. If necessary, each of the imaging pixel, the first focus detecting pixel 201, and the second focus detecting pixel 202 may have a separate pixel configuration, and the first focus detecting pixel and second focus detecting pixel may be partially arranged in a portion of the imaging pixel array.

This embodiment performs focus detection by collecting the light reception signals from the first focus detecting pixel 201 of each pixel on the image sensor 122 to generate a first focus signal, and collecting the light reception signals from the second focus detecting pixel 202 of each pixel to generate a second focus signal. For each pixel on the image sensor 122, the signals from the first focus detecting pixel 201 and the second focus detecting pixel 202 are added together to generate an imaging signal (captured image) with a resolution of N effective pixels. This embodiment is not limited to the example of generating each signal in this manner. For example, the second focus detecting signal may be generated from a difference between the imaging signal and the first focus detecting signal.

### Relationship Between Defocus Amount and Image Shift Amount

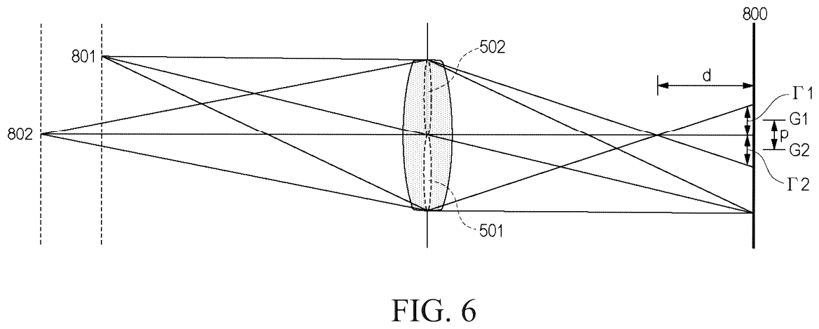

Referring now to FIG. 6, a description will be given of a relationship between a defocus amount and an image shift amount of the first and second focus detecting signals acquired by the image sensor 122 in this embodiment. FIG. 6 is a schematic diagram of a relationship between the defocus amount of the first and second focus detecting signals and the image shift amount between the first and second focus detecting signals.

The image sensor (not illustrated) in this embodiment is placed on an imaging surface 800, and similarly to FIGS. 4 and 5, the pupil plane of the image sensor 122 is divided into the first pupil subregion 501 and the second pupil subregion 502. A defocus amount d has a magnitude |d| which is a distance from the imaging position of the object to the imaging surface, and is defined as a front-focus state in which the imaging position of the object is located on the object side of the imaging surface with a negative sign (d<0). Also, a back-focus state in which the imaging position of the object is located on the opposite side of the object from the imaging surface is defined as a positive sign (d>0). The in-focus state in which the imaging position of the object is located on the imaging surface (focus position) is defined as d=0. In FIG. 6, an object 801 illustrates an example of an in-focus state (d=0), and an object 802 illustrates an example of a front-focus state (d<0). The front-focus state (d<0) and back-focus state (d>0) will be collectively referred to as a defocus state (|d|>0).

In the front-focus state (d<0), a light beam from the object 802 that passes through the first pupil subregion 501 (second pupil subregion 502) is first focused and then spreads to a width Γ1 (Γ2) centered at the center of gravity G1 (G2) of the light beam, forming a blurred image on the imaging surface 800. The blurred image is received by the first focus detecting pixel 201 (second focus detecting pixel 202) that constitutes each pixel arrayed on the image sensor, and a first focus detecting signal (second focus detecting signal) is generated. Therefore, the first focus detecting signal (second focus detecting signal) is recorded as an object image in which the object 802 is blurred with a width Γ1 (Γ2) at the center of gravity G1 (G2) on the imaging surface 800. The blur width Γ1 (Γ2) of the object image increases roughly proportionally as the magnitude |d| of the defocus amount d increases. Similarly, a magnitude |p| of the image shift amount p (=a difference G1−G2 between the center-of-gravity positions of the light beams) of the object image between the first focus detecting signal and the second focus detecting signal increases roughly proportionally as the magnitude |d| of the defocus amount d increases. Even in the back-focus state (d>0), the direction of the object image shift between the first focus detecting signal and the second focus detecting signal is opposite to that in the front-focus state, but this is similarly applied.

As the defocus amount of the first focus detecting signal and the second focus detecting signal, or the imaging signal obtained by adding the first focus detecting signal and the second focus detecting signal, increases, the magnitude of the image shift amount between the first focus detecting signal and the second focus detecting signal increases. Therefore, the phase-difference AF unit 129 converts the image shift amount into a detected defocus amount using a conversion coefficient calculated based on the base length, due to a relationship in which the magnitude of the image shift amount between the first focus detecting signal and the second focus detecting signal increases as the defocus amount of the image signal increases.

### Kalman Filter Calculation

A description will now be given of the Kalman filter calculation used as an estimator for estimating estimated image-plane information (first information on the first image-plane position of the object), which is information corresponding to the image-plane position of the object in this embodiment.

The time-series data y(k) at time k is given by the following equations (1-1) and (1-2). Time-series data is also referred to as observed values. In the following description, time k−1, time k, and time k+1 all correspond to the times at which time-series data is obtained.

$$y ( k ) = {X}^{T} ( k ) A ( k ) + ω ( k ) \qquad ( 1 - 1 )$$

$$A ( k + 1 ) = L ( k ) A ( k ) + m ( k ) v ( k ) \qquad ( 1 - 2 )$$

where X(k) and m(k) are n-dimensional column vectors, A(k) is an n-dimensional column vector (state vector), ω(k) is observation noise with an average value (mean) 0 and variance σ_{ω}², L(k) is an n×n matrix, and v is system noise with the average value 0 and variance σᵥ².

The Kalman filter operation is to calculate the state vector A(k) and is divided into two steps: a prediction step and a filtering step.

First, the state is previously estimated in the prediction step, and then the state is estimated using the observation result in the filtering step. In the prediction step, the prior state estimation vector A′(k) (an n-dimensional column vector) and the prior error covariance matrix P′(k) (an n×n matrix) are calculated using the following equations (2-1) and (2-2), respectively:

$${A}^{′} ( k ) = L ( k - 1 ) A ( k - 1 ) \qquad ( 2 - 1 )$$

$${P}^{′} ( k ) = L ( k - 1 ) P ( k - 1 ) {L}^{T} ( k - 1 ) + {σ}_{v}^{2} ( k - 1 ) m ( k - 1 ) {m}^{T} ( k - 1 ) \qquad ( 2 - 2 )$$

As expressed in equation (2), the prior state estimation vector A′(k) estimates the state vector at time k using the state vector (k−1) obtained at time k−1 and an arbitrary L(k). The prior error covariance matrix P′(k) estimates an error between the state vector A(k) at time k and the prior state estimation vector A′(k). In the filtering step, the state estimation vector A(k) (n-dimensional column vector) is calculated based on the detected time-series data y(k) using the following equation (3-1): A posteriori error covariance matrix P(k) (n×n matrix) is calculated using the following equation (3-2):

$$A ( k ) = {A}^{′} ( k ) + g ( k ) ( y ( k ) - {X}^{T} ( k ) {A}^{′} ( k ) ) \qquad ( 3 - 1 )$$

$$P ( k ) = ( I - g ( k ) {X}^{T} ( k ) ) {P}^{′} ( k ) \qquad ( 3 - 2 )$$

As illustrated in equation (3-1), A(k) is calculated by adding a correction value obtained by multiplying a difference between the actual detection result y(k) and the predicted detection result X^{T}(k)A′(k) by the Kalman gain g(k), to A′(k). Matrix I is an n×n identity matrix. The Kalman gain g(k) is calculated using the following equation (4):

$$g ( k ) = \frac{{P}^{′} ( k ) X ( k )}{{σ}_{ω}^{2} + {X}^{T} ( k ) {P}^{′} ( k ) X ( k )} \qquad ( 4 )$$

As illustrated in equation (4), the larger the observation noise σ_{ω}²(k) is, the smaller g(k) is. The larger the prior error covariance matrix P′(k) is, the smaller g(k) is. That is, in a case where there is a high probability that the detected y(k) or X^{T}(k)A′(k) contains errors, g(k) will be smaller than that in other cases. Thereby, the calculated A(k) is less susceptible to errors. An initial value A(0) of the state vector and the initial value P(0) of the error covariance matrix are given by the following equations (5-1) and (5-2), respectively.

$$A ( 0 ) = [ \begin{matrix}{a}_{0} ( 0 ) \\ {a}_{1} ( 0 ) \\ … \\ {a}_{n - 1} ( 0 )\end{matrix} ] \qquad ( 5 - 1 )$$

$$P ( 0 ) = {p}_{0} I \qquad ( 5 - 2 )$$

Kalman Filter Calculation in this Embodiment

A description will now be given of the Kalman filter calculation in this embodiment. y(k) is a detection result of the image-plane position at time k. In this embodiment, the image-plane position and image-plane moving speed at time k are estimated from the state vector A(k) as information about the state of the object. By calculating the state vector A(k+1) based on the state vector A(k), the image-plane position and image-plane moving speed at time k+1 are estimated as information about the state of the object.

In this embodiment, the image-plane position refers to a position of the back focal point corresponding to the focus lens 104 (also referred to as the image-plane position of the imaging optical system or the lens image-plane position). The image-plane position corresponding to an object is the position of the back focal point in a case where the focus lens 104 is located at a position that provides the front focal point for the object. In other words, the image-plane position corresponding to an object is a position of the back focal point calculated at the time when focus detection is performed for the object by adding the defocus amount to the position of the back focal point at that time. In this embodiment, this is called the object image-plane position.

This embodiment will discuss an example in which the image-plane position is used as information corresponding to the image-plane position, but information other than the image-plane position may also be used as information corresponding to the image-plane position. For example, since the image-plane position corresponds to the position of the focus lens 104, the position of the focus lens 104 corresponding to the image-plane position may be used instead of the image-plane position in this embodiment. In this case, the lens position corresponding to the image-plane position corresponding to the object is a focus lens position calculated as follows. That is, it is a position of the focus lens calculated at the time when focus detection is performed for the object, by adding the defocus amount to the focus lens position at that time.

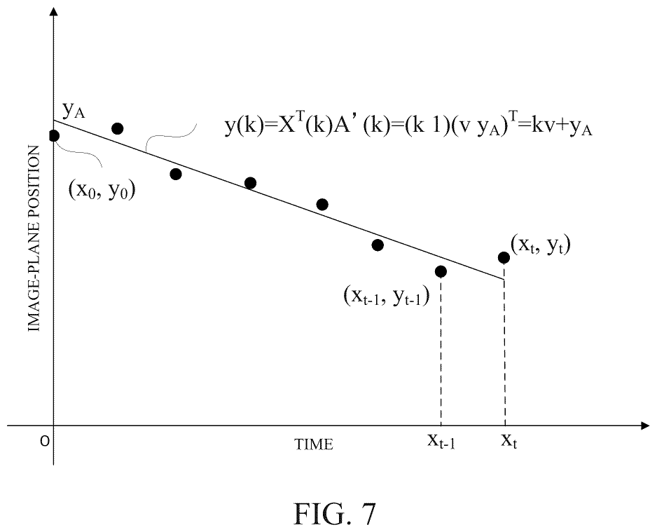

Referring now to FIG. 7, a description will be given of a model equation for predicting the motion of an object using information about the state of the object (the image-plane position and image-plane moving speed estimated by Kalman filter calculation). FIG. 7 illustrates the Kalman filter calculation in this embodiment, as an example. In FIG. 7, the horizontal axis represents time, and the vertical axis represents an image-plane position.

Assume that an image-plane position corresponding to an object is predicted using a linear (two-dimensional) equation, as illustrated by a solid line in FIG. 7. The image-plane position at time k is a model predictable using the average image-plane moving speed v at time k and the image-plane position y_{A} at time 0. In this case, column vector A is defined as the image-plane position (intercept) y_{A} at time 0 and the average image-plane moving speed (slope) v at time k. Column vector X is defined as 1 so that time k and y_{A} are constants. The variance σ_{ω}² can be set based on the variance of the detection result. For the initial value A(0), the initial value of y_{A} may be set, for example, based on the first detected image-plane position y₀. The initial value v of the average image-plane moving speed may be set to 0. A proper value can be set for the initial value P(0). The matrix L, column vector m, and variance σᵥ² can be set based on the properties of the model, i.e., the properties of the motion of the object to be captured, and may be time-invariant.

The image-plane moving speed is the speed at which the image-plane position moves, and corresponds to the moving speed of the object. This embodiment uses the image-plane moving speed, but is not limited to this example as long as it corresponds to the image-plane moving speed. For example, it may be the moving speed of the focus lens position corresponding to the moving speed of the image-plane position. While this embodiment uses a linear (two-dimensional) model equation as an example, the model equation may have any number of dimensions according to the expected motion of the object, and the column vector A can be defined to match the dimension of the model equation.

As described above, the matrices, vectors, and variances for the prediction step are defined. Thereafter, repeating the filtering step and the prediction step using the detected image-plane position, a model equation for estimating the motion of the object can be obtained using the Kalman filter calculation. As described above, the Kalman filter calculation is based on errors, and thus allows for accurate estimation of the image-plane position even in situations where the errors are likely to occur in the focus detection result. In this embodiment, the image-plane position and image-plane moving speed estimated by the Kalman filter calculation will be collectively referred to as estimated image-plane information.

### Motion Determination

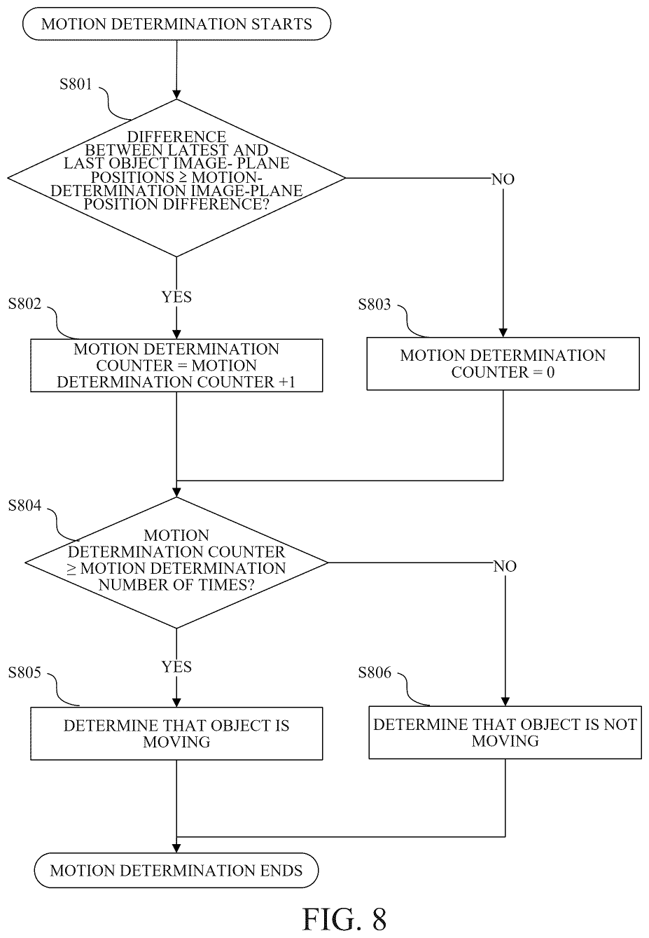

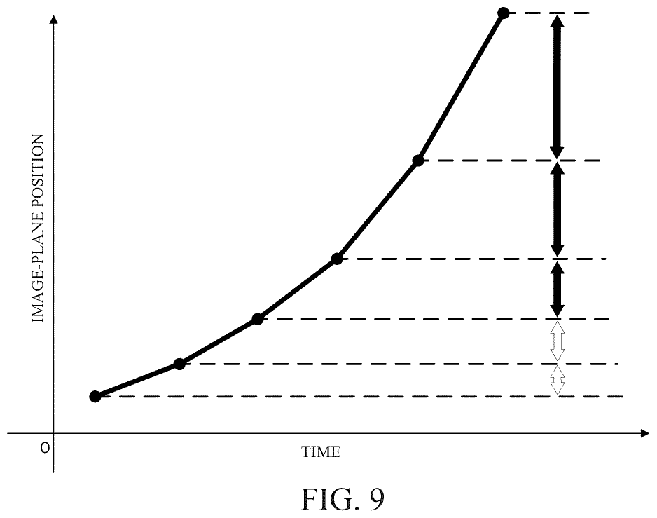

The motion determination according to this embodiment will be described in detail with reference to FIGS. 8 and 9. FIG. 8 is a flowchart illustrating the motion determination processing. Each step in FIG. 8 is executed primarily by the camera MPU 125.

First, in step S801, the camera MPU 125 periodically perform focus detection for an object and acquires the object image-plane position (image-plane position of the object). The camera MPU 125 then determines whether a difference between the object image-plane position at the latest focus detection and the object image-plane position at the last focus detection period is equal to or greater than a motion determination image-plane position difference (first threshold value).

The motion determination image-plane position difference is a threshold value used to determine whether an object has moved, using a difference between two periodically detected, chronologically adjacent object image-plane positions. FIG. 9 illustrates an example of the object image-plane position for motion determination. In FIG. 9, the vertical axis represents the object image-plane position, and the horizontal axis represents the time when focus detection is performed. In the vertical axis, the up direction represents an image-plane position in the infinity direction, while the down direction represents an image-plane position in the close-distance direction. In addition, in FIG. 9, a black dot indicates an object image-plane position at each time when focus detection is performed, and it is assumed that the focus lens does not move while a focus detecting signal for focus detection is captured. Of the differences between chronologically adjacent object image-plane positions, a difference equal to or greater than the motion determination image-plane position difference is indicated by a solid black arrow, and a difference less than the motion determination image-plane position difference is indicated by an outline arrow.

In a case where, in step S801, a difference between the latest and last object image-plane positions is equal to or greater than the motion determination image-plane position difference, the flow proceeds to step S802. On the other hand, in a case where the object image-plane position difference is less than the motion determination image-plane position difference, the flow proceeds to step S803. In step S802, the camera MPU 125 counts up a motion determination counter, which indicates the number of times it was determined in step S801 that the object had moved.

In step S803, since it has been determined in step S801 that the object had not moved, the camera MPU 125 initializes the motion determination counter to 0. For example, in FIG. 9, the difference between the most recently chronologically adjacent object image-plane positions is equal to or greater than the motion determination image-plane position difference three consecutive times, so the motion determination counter is set to 3.

In step S804, the camera MPU 125 determines whether the motion determination counter is equal to or greater than the motion determination number of times. In a case where the motion determination counter is equal to or greater than the motion determination number of times, the flow proceeds to step S805. On the other hand, in a case where the motion determination counter is less than the motion determination number of times, the flow proceeds to step S806. Here, the motion determination number of times is a threshold value (second threshold value) that is used to determine that the object is a moving object, using the number of consecutive times it was determined that the object has moved in step S801. For example, in FIG. 9, the motion determination counter is set to 3, so in a case where the motion determination number is 3 or less, the object is determined to be a moving object, and the flow proceeds to step S805.

In step S805, the camera MPU 125 determines that the object is in a state that is evaluated as moving (the motion of the object is in a first state). In step S806, the camera MPU 125 determines that the object is in a state where it is evaluated as not moving (the motion of the object is in a second state). The camera MPU 125 then terminates the motion determination processing.

### Calculation of Predicted Image-Plane Position

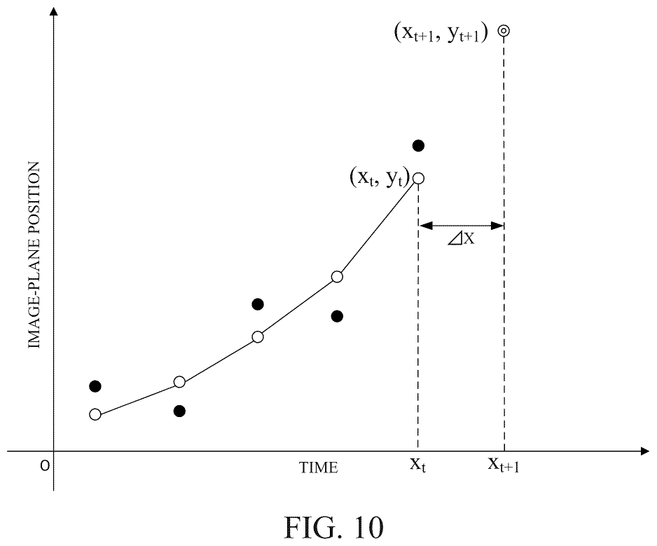

Referring to FIG. 10, a description will be given of the calculation of the predicted image-plane position (predicted image plane information, i.e., second information on the future second image-plane position of the object) in this embodiment. FIG. 10 illustrates an example of the object image-plane position for calculating the image shift amount. In FIG. 10, the vertical axis represents the object image-plane position, and the horizontal axis represents the time at which focus detection is performed.

In FIG. 10, a black dot represents the object image-plane position when focus detection is detected at each time, and a white dot represents the image-plane position estimated by applying a Kalman filter to the object image-plane position when focus detection is detected up to that time. Time xₜ is the time when the latest focus detecting signal is captured, time xₜ₊₁ is the time when the next focus detecting signal is captured, and Δx is a difference between time xₜ and time xₜ₊₁, i.e., a time lag until imaging. yₜ is an image-plane position estimated at time xₜ. A double white dot represents a predicted image-plane position for the next imaging, and yₜ₊₁ is an image-plane position predicted at time xₜ₊₁. In this embodiment, this predicted image-plane position is treated as the predicted image shift amount. Where vₜ is an image-plane moving speed at time xₜ estimated using the Kalman filter, the predicted image-plane position yₜ₊₁ after the time lag Δx has elapsed can be calculated using the following equation (6):

$${y}_{t + 1} = {v}_{t} Δ x + {y}_{t} \qquad ( 6 )$$

In this embodiment, an image shift amount (second information) is calculated using an estimated image-plane information (first information) obtained from the Kalman filter. However, another known method may also be used.

### Focusing Processing

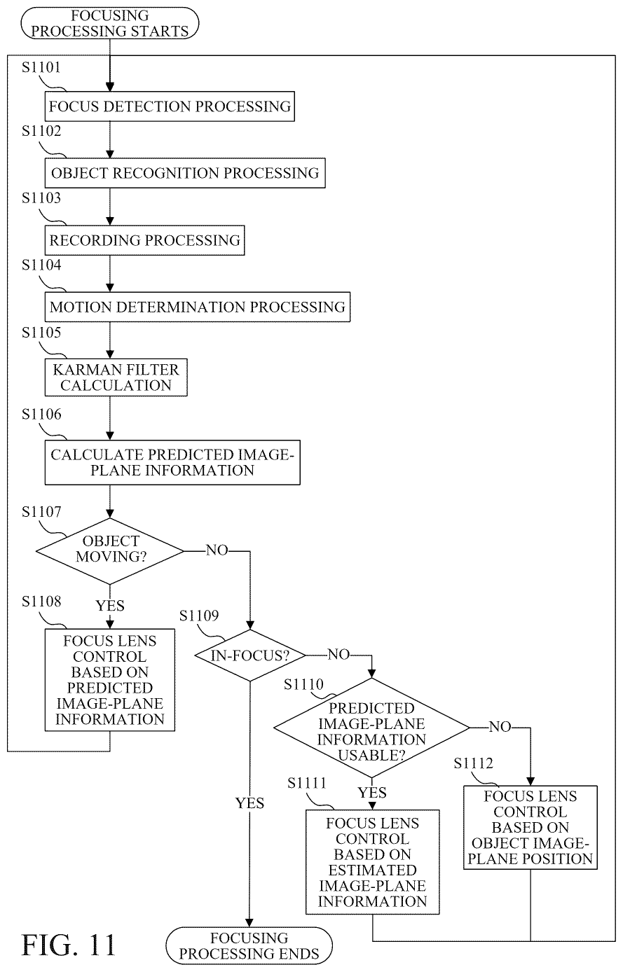

Referring now to FIG. 11, a description will be given of the focusing processing according to this embodiment. FIG. 11 is a flowchart illustrating the focusing processing. Each step in FIG. 11 is executed by each component of the imaging system 10 primarily in accordance with commands from the camera MPU 125.

First, in step S1101, the camera MPU 125 performs focus detection processing. That is, using the image sensor 122 and phase-difference AF unit 129, the camera MPU 125 captures an image signal and a focus detecting signal, performs focus detection using these signals, and calculates a defocus amount and an object image-plane position.

Next, in step S1102, the camera MPU 125 performs object recognition processing. That is, using the object recognizer 132, the camera MPU 125 recognizes a specific object, such as a person or an animal, from the image signal obtained in step S1101. Next, in step S1103, the camera MPU 125 performs recording processing to record the time-series object image-plane positions obtained in step S1101 in the memory 128. Next, in step S1104, the camera MPU 125 performs motion determination processing. That is, the camera MPU 125 performs motion determination as described with reference to FIG. 8 based on the time-series object image-plane positions recorded in step S1103.

Next, in step S1105, the camera MPU 125 performs Kalman filter calculation. That is, the camera MPU 125 performs the Kalman filter calculation described above based on the time-series object image-plane positions recorded in step S1103, and estimates the image-plane position and image-plane moving speed, which are estimated image-plane information (first information). Next, in step S1106, the camera MPU 125 calculates the image shift amount (second information). That is, the camera MPU 125 calculates the image shift amount described above based on the estimated image-plane information and the time lag until the next imaging time (a period from the last imaging time to the next imaging time).

Next, in step S1107, the camera MPU 125 determines whether the object is moving based on the result of the motion determination processing in step S1104. In a case where the object is moving (in a case where the object motion is in the first state), the flow proceeds to step S1108. On the other hand, in a case where the object is not moving (in a case where the object motion is in the second state), the flow proceeds to step S1109.

In step S1108, the camera MPU 125 controls the focus lens 104 based on the image shift amount. That is, the camera MPU 125 drives the focus lens 104 toward the predicted image-plane position, which is the image shift amount acquired in step S1106.

In step S1109, the camera MPU 125 determines whether the focus state is in focus. For example, in a case where the defocus amount acquired in step S1101 is equal to or less than a predetermined amount, the camera MPU 125 determines that the focus state is in focus. On the other hand, in a case where the defocus amount is greater than the predetermined amount, the camera MPU 125 determines that the focus state is not in focus. In a case where the focus state is in focus, the focusing processing ends. On the other hand, in a case where the focus state is not in focus, the flow proceeds to step S1110.

In step S1110, the camera MPU 125 determines whether or not the estimated image-plane information can be used. For example, in a case where the time-series object image-plane positions applied to the Kalman filter are equal to or greater than a predetermined history number and the estimated image-plane information can be used, the flow proceeds to step S1111. On the other hand, in a case where the time-series object image-plane positions are less than the predetermined number of histories and the estimated image-plane information cannot be used, the flow proceeds to step S1112.

In step S1111, the camera MPU 125 controls the focus lens 104 using the estimated image-plane information. That is, the camera MPU 125 drives the focus lens 104 toward the image-plane position estimated by the Kalman filter calculation in step S1103.

In step S1112, the camera MPU 125 controls the focus lens 104 using the object image-plane position. That is, the camera MPU 125 drives the focus lens 104 toward the object image-plane position acquired by the focus detection processing in step S1101. That is, in a case where the control unit 1253 cannot acquire the first information using a predetermined history number of time-series focus detection results or more, it controls the focus lens 104 using the third information on the third image-plane position of the object obtained using the last acquired focus detection result. After steps S1108, S1111, and S1112 are executed, the camera MPU 125 performs processing again from step S1101 for the next imaging.

As discussed, an object with a large change in focus position is determined to be a moving object. In this case, focus trackability can be improved by controlling the focus lens 104 based on the predicted image shift amount. On the other hand, an object with a small change in focus position is determined to be a fixed object. In this case, the focus lens 104 can be controlled based on estimated image-plane information. Using the estimated image-plane information can provide focus tracking based on changes in the object image-plane position using a Kalman filter, and maintain a stable focus position even in situations where errors in focus detection results are likely to occur.

In the focus determination in step S1109, it may be determined the in-focus state in a case where a difference between the estimated image-plane position and the lens image-plane position is equal to or smaller than a predetermined difference. This allows the focus position to be stabilized by stopping the drive of the focus lens 104, even in situations where errors are likely to occur in the focus detection result. The Kalman filter has the property that estimated image-plane information does not converge and fluctuates in a case where there are few time-series object image-plane positions. Thus, it may be determined that the image is not in focus in a case where the time-series object image-plane positions applied to the Kalman filter are less than a predetermined history number. This prevents a false determination that the image is in focus due to estimated image-plane information before convergence or a defocus amount equal to or smaller than a predetermined amount that is erroneously detected in situations where errors are likely to occur in the focus detection results.

In the Kalman filter calculation in step S1105, parameters for the Kalman filter calculation may be set (changed) in accordance with the motion determination processing in step S1104. That is, the control unit 1253 may change the parameters used to acquire estimated image-plane information in accordance with the motion of the object.

As described above, in the Kalman filter calculation, the matrix L and column vector m may be set according to the properties, such as the motion of the object to be captured. Therefore, by determining that the properties, such as the motion of the object, have changed based on the motion determination result and by setting the matrix L and column vector m, it is possible to obtain more accurate estimated image-plane information that matches the motion of the object. Alternatively, the type of object recognized in the object recognition processing of step S1102 may be used to determine that the properties, such as the motion of the object, have changed, and the matrix L and column vector m may be set. That is, the control unit 1253 may change the parameters that are used to acquire estimated image-plane information according to the object type.

In a case where the object recognized in the object recognition processing of step S1102 has changed, the recording processing of step S1103 may discard the time-series object image-plane positions recorded up to that point, and record the object image-plane positions from the imaging in which the object changed. That is, in a case where the object is switched from a first object to a second object, the first acquiring unit 1251 may acquire estimated image-plane information using the time-series focus detection results for the second object acquired after the switch.

At the same time, the state estimation vector A(k) and the posterior error covariance matrix P(k) calculated in the Kalman filter calculation in step S1105 may be discarded, and the Kalman filter calculation may be performed again with the initial value A(0) of the state vector and the initial value P(0) of the error covariance matrix. This can prevent, in a case where an object is switched, a situation in which a proper estimated image-plane position for the switched object cannot be calculated due to the influence of the object image-plane position before the switch.

The imaging system 10 according to this embodiment may be able to capture both moving and still images. In this embodiment, in a case where the imaging state of the imaging system 10 is a still image capturing state, the control unit 1253 may not use estimated image-plane information for the focus determination and the control of the focus lens 104. In other words, in a case where the imaging state is a still image capturing state, the control unit 1253 may prohibit the use of estimated image-plane information in the focus determination in step S1109, and always set the determination of whether or not to use estimated image-plane information in step S1110 to “NO” to prohibit focus lens control based on the estimated image-plane information. This prevents a decrease in AF responsiveness during still image capturing, which requires better AF responsiveness than during moving image capturing, in a case where the estimated image-plane information lags behind the actual motion of the object due to the influence of the time-series object image-plane positions.

In the recording processing of step S1103, estimated image-plane information calculated using a Kalman filter based on the last imaging may be recorded in chronological order, and the motion determination in step S1104 may use the time-series estimated image-plane positions instead of the time-series object image-plane position. This can suppress erroneous motion determination results by using accurate estimated image-plane information, even in situations where errors are likely to occur in the focus detection result.

As described above, in this embodiment, the control unit 1253 changes the information that is used for controlling the focus lens 104 according to whether or not the object is moving. For example, in a case where the motion of the object is in the first state (a state in which it is evaluated as not moving), the control unit 1253 controls the focus lens 104 using the estimated image-plane information (first information). On the other hand, in a case where the object is in a second state (a state evaluated as moving) where the motion of the object is greater than in the first state, the control unit 1253 controls the focus lens 104 using the image shift amount (second information). The object moves in the optical axis direction of the imaging optical system.

This embodiment can properly track a moving object and improve focusing stability even when the defocus amount varies. Therefore, each embodiment can provide a control apparatus, an image pickup apparatus, a control method, and a storage medium, each of which can provide stable focusing.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-229419, filed on Dec. 25, 2024, which is hereby incorporated by reference herein in its entirety.

What is claimed is:

1. A control apparatus comprising:
one or more memories storing instructions; and
one or more processors that, upon execution of the instructions, operate to:
acquire first information on a first image-plane position of an object using time-series focus detection results based on image signals obtained from an image sensor,
acquire second information on a future second image-plane position of the object using the first information,
control a focus lens using the first information in a case where a motion of the object is in a first state, and
control the focus lens using the second information in a case where the motion of the object is in a second state greater than the first state.

2. The control apparatus according to claim 1, wherein in a case where the motion of the object is in the first state, the one or more processors operate to perform a focus determination using the first information.

3. The control apparatus according to claim 2, wherein in a case where an imaging state is a still image capturing state, the one or more processors do not use the first information for making the focus determination and controlling the focus lens.

4. The control apparatus according to claim 1, wherein the first information includes information on an image plane moving speed estimated using the time-series focus detection results.

5. The control apparatus according to claim 1, wherein the first information includes information on an image-plane position estimated using the time-series focus detection results.

6. The control apparatus according to claim 1, wherein the second information is predicted based on the first information and a period from last imaging time to next imaging time.

7. The control apparatus according to claim 1, wherein the motion of the object is a motion in an optical axis direction of an imaging optical system.

8. The control apparatus according to claim 1, wherein the one or more processors operate to change parameters for acquiring the first information in accordance with the motion of the object.

9. The control apparatus according to claim 1, wherein the one or more processors operate to change parameters for acquiring the first information in accordance with a type of the object.

10. The control apparatus according to claim 1, wherein in a case where the object recognized using the image signals switches from a first object to a second object, the one or more processors operate to acquire the first information using the time-series focus detection results related to the second object acquired after the switch.

11. The control apparatus according to claim 1, wherein in a case where the one or more processors cannot acquire the first information using a predetermined history number of time-series focus detection results or more, the one or more processors operate to control the focus lens using third information on a third image-plane position of the object acquired using a last acquired focus detection result.

12. The control apparatus according to claim 1, wherein in a case where the one or more processors operate to determine the motion of the object using the first information.

13. An image pickup apparatus comprising:
a control apparatus; and
an image sensor;
wherein the control apparatus includes:
one or more memories storing instructions, and
one or more processors that, upon execution of the instructions, operate to:
acquire first information on a first image-plane position of an object using time-series focus detection results based on image signals obtained from an image sensor,
acquire second information on a future second image-plane position of the object using the first information,
control a focus lens using the first information in a case where a motion of the object is in a first state, and
control the focus lens using the second information in a case where the motion of the object is in a second state greater than the first state.

14. A control method comprising:
acquiring first information on a first image-plane position of an object using time-series focus detection results based on image signals obtained from an image sensor;
acquiring second information on a future second image-plane position of the object using the first information;
controlling a focus lens using the first information in a case where a motion of the object is in a first state; and
controlling the focus lens using the second information in a case where the motion of the object is in a second state greater than the first state.

15. A non-transitory computer-readable storage medium storing a program that causes a computer to execute the control method according to claim 14.
